(19) United States
(12) Patent Application Publication
(10) Pub. No.: US 2008/0072334 A1
(43) Pub. Date: Mar. 20, 2008

(54) SYSTEM AND METHOD FOR ELECTRONIC COLLABORATION

(76) Inventors: Todd Bailey, Benton, AR (US); Jonathan D. Bailey, Benton, AR (US); Christopher L. Eley, Alexander, AR (US); Rex L. Eley, Little Rock, AR (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/856,995

(22) Filed: Sep. 18, 2007

Related U.S. Application Data
(60) Provisional application No. 60/826,001, filed on Sep. 18, 2006.

(51) Int. Cl. G06F 21/22

(52) U.S. Cl. 726/28

(57) ABSTRACT

A system for providing users with electronic access to multiple electronic collaboration services via a single electronic work center with a single user home page is disclosed that provides routing of users amongst multiple electronic work centers, each with access to a centralized electronic signature service. User information remains accessible from the user's home page while the user accessed functionality in other work centers can be controlled according to the access and authority credentials and rules specified by each third party work center administrator. In addition, electronic signatures can be applied in the work center environment, including via integrated audio and web conferencing with document management. The work center environment can be used to manage an electronic document to be electronically signed by any number of individuals in remote locations, with any of these signings being performed on a single computer in a single location hosted by an independent third.

### BACKGROUND

1. Field of the Invention

Embodiments of the invention concern methods and systems for providing users with electronic access to multiple electronic collaboration services via a single electronic work center, and more specifically to systems and methods for routing users amongst multiple electronic work centers each with access to a centralized digital signature service.

2. Background

Systems exist that provide various electronic business services to users via a document management system or an electronic work center over the Internet. For example, various companies provide commercially available electronic work space systems for organizing, sharing, collaborating and performing various tasks using electronic documents and communications. Additionally, solutions exist for providing electronic video conferencing, audio conferencing, and similar services.

Prior systems for providing these various services often rely on proprietary technology and individual company intranets that do not allow a user to maintain a common work space while accessing different work centers owned and controlled by other parties. Such systems could be used for one specific purpose or function, but when a user needed to perform other functions or needed to perform activities for a different purpose, especially with parties in other companies and other locations, such systems would not be able to accommodate that user. The user would then be required to access a different work center to deal with each different company or access multiple, non-integrated services provided by various application service providers. In a similar fashion, various companies provide commercially available systems for applying electronic signatures to documents, messages, and other electronic content.

None of the above systems, however, provide users with access to all of the key services needed to automate important work processes in an efficient and effective manner. As an example of an important service absent from these systems is a centralized digital signature service, in particular for applications where there are multiple signers in two or more remotely located groups that need to sign a document from a single computer.

Likewise, none of the existing services for electronic video conferencing, audio conferencing, and similar services provide access to a centralized digital signature service and those systems offer only limited services related to document management and organization, task management, and other important elements of electronic work center collaboration. None of the existing electronic work space or conferencing providers provide a user a way to interface with the work spaces of third parties while maintaining concurrent access to important personal and business information for the user's own work space or a way to seamlessly move among third party work spaces to which the user has been given access without manually logging into each work space.

Further, none of the above systems provide an integrated system that will easily and seamlessly permit a user to access multiple work centers. These systems also do not provide an integrated workflow system that will easily and seamlessly permit multiple users to apply digital signatures to electronic documents in a manner compliant with E-SIGN and UETA statutory requirements when the signers are located together in one or more remotely located groups using the same computer, for example as part of work center collaboration using web conferencing.

There is therefore a need in the art for systems and methods for allowing an authorized user to access (from a single user home page), multiple network-based electronic work centers that could be operated by multiple third parties, with the user's authority and ability to access documents and other information in each work center controlled by the respective work center's owner or administrator. There is also a need in the art for systems and methods for allowing an authorized user of these work centers to be able to collaborate with other authorized users and/or with one or more third-party non-authorized users through various means including document management systems, integrated web and audio conferencing, and application of digital signatures to electronic documents in a manner that fully complies with applicable state and federal law.

### SUMMARY

Embodiments disclosed herein address the above stated needs by allowing an authorized user to access from a single user home page, multiple intranet, extranet or Web-based electronic work centers operated by multiple third parties. In an embodiment, the user's authority and ability to access documents and other information in each work center can be controlled by the respective work center's owner or administrator, while the user's “to do” list, contacts, calendar, personal information contained on the user's home page remains unique to the user and not to the work center in which the user is working. It will be apparent to a person skilled in the art that any number of other types of user information also could remain accessible from the user's home page while the user accessed content and functionality in third party work centers according to the access and authority credentials and rules specified by each third party work center owner/administrator.

Accordingly, some embodiments of the present invention allow the owner or administrator of an electronic work center to control user access and authority at multiple distinct levels of organization. In an embodiment, some of those distinct levels can include work center, matter or project, and document. In an embodiment of these distinct levels of organization in an electronic work center, the owner or administrator may also establish multiple levels of access and authority at each level of organization. In another embodiment, the combination of these multiple levels of access and authority at each of the multiple levels of organization can be used to control what the user can see and do in a manner that accommodates multiple parties involved in multiple roles with different needs to “know and do” inherent in complex business and litigation matters.

According to another embodiment of the invention, a method provides for organizing and instantly time stamping and filing documents, comments, forms, tasks and communications by folders established for divisions or categories of work within the work center, by project/matter, by folders established for divisions or categories of work within a project/matter, and by document.

Other embodiments of the invention provide systems and methods for implementing electronic signatures in a work center environment. Accordingly, an embodiment of the invention provides integrated audio and web conferencing with document management and electronic signature functions of a web-based electronic work center so that conference participants can enter into a legally enforceable contract upon completion of the conference presentation and agreement on terms in a manner where all conference participants can witness and/or track the signing by each party and where each signer can receive a signed copy of the document prior to completion of the conference.

In another embodiment, a method can convert a wide variety of electronic document formats into a format appropriate for applying an electronic signature and can collect pertinent signer information from any number of signers to be applied dynamically to a signature page and attached to a document (or pertinent signer information from any number of signers can be applied directly to a location within a document) for electronic signature in a manner that can require that the signing process either be signed sequentially by the signers in a predetermined order or can be signed randomly by the signers based on the order in which the signers access the document for signature.

Similarly, according to another embodiment a method initiates and manages an electronic document to be signed by any number of individuals in any number of remote locations, with any of these signings being performed on a single computer in a single location hosted by an independent third party (such as an e-notary, attorney or retail outlet).

In another embodiment, a method verifies the identity of one or more signers of an electronic document by requiring each signer to use a biometric identifier to actually trigger the electronic signature process—not just access the document.

In yet another embodiment, a method allows an authorized user to initiate an electronic signature job, which includes the requirement for e-notarization of one or more signatures and which provides a means for the e-notary to apply the information and/or images to the signature block as required to notarize the signature(s), without the signature job originator knowing the name of the notary or the requirements of the state in which the notary will perform the service.

Exemplary embodiments of the invention shown in the drawings are described below. Other advantages and features associated with embodiments of the present invention will become more readily apparent to those skilled in the art from the following detailed description. As will be realized, the invention is capable of other and different embodiments, and its several details are capable of modification in various obvious aspects, all without departing from the invention. Accordingly, the drawings in the description are to be regarded as illustrative in nature, and not limitative.

### BRIEF DESCRIPTION OF THE DRAWINGS

FIG. 1 is a block diagram of a system, including a processor system and multiple work centers, according to an embodiment of the invention.

FIG. 2 is a functional block diagram of a work center manager, according to an embodiment of the invention.

FIG. 3A is a screen shot of a home page within a work center (implemented as a business center) from the perspective of an end user, according to an embodiment of the invention.

FIG. 3B is a screen shot showing an end user's ability to switch from one business center to another business center.

FIG. 4 is a functional block diagram of a digital signature manager, according to an embodiment of the invention.

FIG. 5A is a screen shot of a digital signature application from the perspective of an end user, according to an embodiment of the invention.

FIG. 5B is another screen shot of a digital signature application from the perspective of an end user, according to an embodiment of the invention.

FIG. 5C is another screen shot of a digital signature application from the perspective of an end user, according to an embodiment of the invention.

FIG. 5D is another screen shot of a digital signature application from the perspective of an end user, according to an embodiment of the invention.

FIG. 6 is a flow chart depicting the process of building the multi-center routing main page for a user, according to an embodiment of the invention.

FIG. 7 is a flow chart depicting the process of verifying the level of authority and access for a user, according to an embodiment of the invention.

FIG. 8 is a flow chart depicting the process of initiating a digital signature process for a user, according to an embodiment of the invention.

FIG. 9 is a flow chart depicting the conversion of a document into PDF format, according to an embodiment of the invention.

FIG. 10 is a flow chart depicting the notification of outstanding document signers, according to an embodiment of the invention.

FIG. 11 is a flow chart depicting the process of completing a digital signature process for a user, according to an embodiment of the invention.

### DETAILED DESCRIPTION

A work center or business center, according to various embodiments of the current invention, can be capable of performing a wide variety of electronic work flow procedures for automating or facilitating numerous diverse business applications. By way of example but not limitation, these work centers can include integrating the systems and methods for implementing electronic signatures into web conferencing software, e-notary software, loan closing software, employment or staffing agency software, insurance agency software, real estate agency software, regulatory agency software, or legal services software. Various implementations of work centers may reside on one or more individual computers, be part of a server-based intranet or extranet, or be deployed over the Internet via the World Wide Web.

In various embodiments, electronic work centers can include various types of electronic systems and methods for automating business processes are assembled, integrated, and made accessible to one or more users via a secure log in protocol either on a server-based intranet or extranet or via a web browser on the Internet. A work center can also include a software system comprised of multiple functional modules or components designed to perform electronic work flows and transactions that can be used to automate work processes and tasks specific to a user's needs and affiliation. An example of such a work center is the ConXPoint system provided by CXP Solutions LLC of Little Rock, Ark.

In an embodiment, a work center can be designed so that it can easily be customized according to the branding, look, organization, and content unique to the work center owner's needs and affiliation. The work center also can be secured by an access requirements protocol deployed at the work center level and at multiple other levels of organization within the work center. In an embodiment, for example, a work center can be organized into divisions such as work center folders, with each folder containing projects or matters, and with each project or matter containing folders within which documents, communications and other content, including multiple versions of same, may be automatically time stamped, filed, and archived (along with audit trails of access/views).

An access requirements protocol can be deployed at the project/matter level and at the document level, in addition to at the work center level in an embodiment of the invention. Further, requirements for multiple levels of user authority may be established at each organizational level. For example, at the work center level the highest level of authority might be designated as work center administrator with an ability to access and use all functionality and content in the work center, the next highest level of authority might be designated as work center manager with an ability to access and use all functionality and content except for designated administrators or changing work center level control settings, and the final level of work center authority might be work center restricted with no ability to access or do anything that is not specifically authorized on a project/matter by project/matter basis. Multiple levels of access and authority also can be established at the project/matter level and at the document level of organization or at any other levels by whatever name known. For example, at the project/matter level, the matter manager might be able to access and do everything within the project/matter they establish or to which they are given access by a work center administrator or work center manager, while a matter participant can only upload documents and perform other functions authorized by the matter manager on a case by case basis. Additionally, a restricted user at the project/matter level may only be aware of the presence of other users in the project/matter or might be able to only view and perform functions on documents as may be authorized on a document by document basis by the matter manager. Thus, access and authority related to all aspects of a work center can be controlled in a granular manner that ensures security of information and access on a need to know basis in even the most complex legal and business endeavors.

Further, a variety of security and permissioning methods can be used to enforce the access and authority protocols. By way of example and not limitation, these methods may include secure socket layer encryption, biometric identity authentication, and shared secret information protocols. A work center can also be designed so that both registered users (e.g., users who have completed a registration process at the invitation and with the approval of an authorized work center administrator or work center manager of that work center) and non-registered users (e.g., a person who has not been registered or approved as a registered user of a work center; a guest) can perform certain tasks upon request of a project/matter manager. For example, an attorney, who is authorized as a matter manger in his or her law firm's work center, might request a client who is a registered user and who is selling piece of property to sign a contract of sale, while the buyer, who is not a registered user, would be asked to sign the contract as a non-registered user. This feature of the invention allows work center users to interact with a third party to perform selected business functions without asking them to become a registered user if the third party is a one-time or infrequent user of the work center.

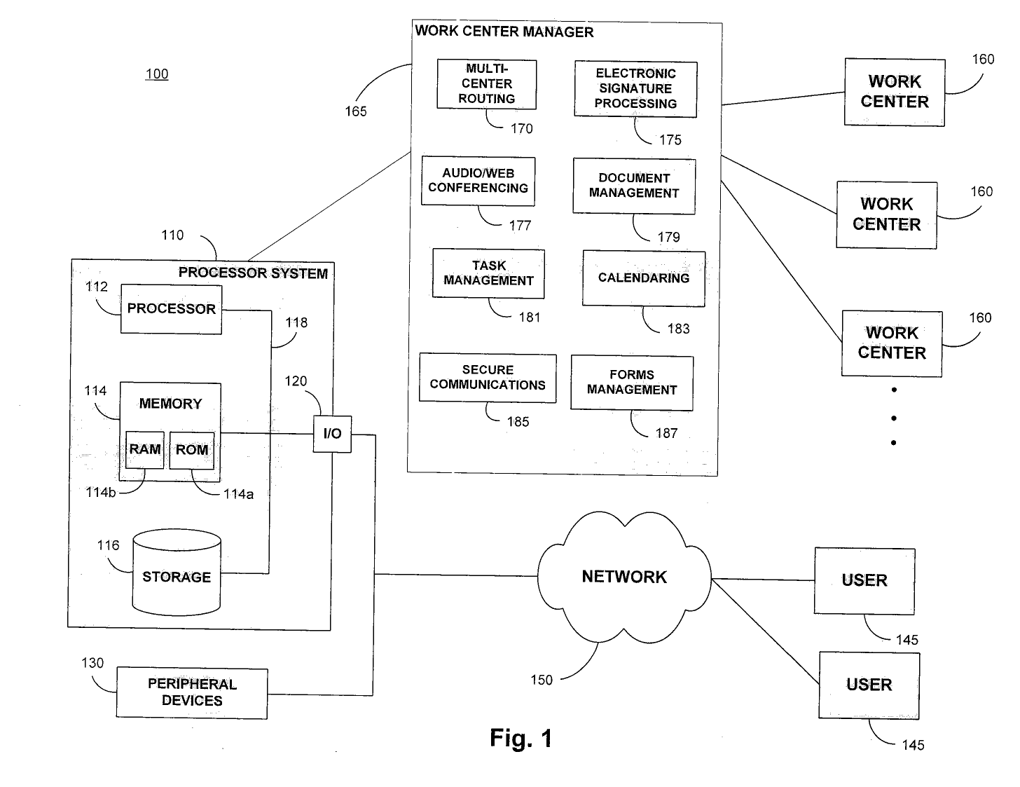

FIG. 1 is a block diagram of a processor system 110, a work center manager 165, and work centers 160 connected to a network 150, according to an embodiment of the invention. An electronic work center (also referred to herein as a work space or business center) comprises the functionality needed by a user to perform electronic work flows and transactions that can be used to automate work processes and tasks specific to that user's needs and affiliation that otherwise would require more time and/or expense to perform. An electronic work center, for example, could include a set of functions for an employee to perform many or all of his or her job duties that previously were performed using written paper, face-to-face or telephone communications or requiring mechanical equipment, travel or other more time consuming and expensive processes. As a more specific example, a sales person might need to make a sales presentation to a prospective customer with two key decision makers located in different remote locations. The sales person could use web conferencing to present the proposal, audio conferencing to negotiate the terms of the agreement, and an electronic signature service to get the contract signed by all parties while they are looking at the document via web conferencing, and then use a document management system to instantly deliver and file signed copies of the contract for all parties. Once the new customer sale is consummated, another employee that performs purchasing might need access to a parts catalog, a pricing list, and the overall company inventory as part of fulfilling the new customer's order. All of these resources might be available over a company intranet, but not be integrated with the sales process or with key suppliers. Upon making decisions about what to purchase, the employee in purchasing would then need to know which suppliers have the items needed in stock and the price and delivery options. This information would require the purchaser to access the supplier's work center to verify availability, price, delivery information and place the order.

The various elements in FIG. 1 are shown in a network-computing environment 100, wherein a processor system 110 is interconnected with a network 150, by which the processor system 110, work center manager 165, and work centers 160 can communicate. It will be appreciated that the elements shown in FIG. 1 are examples of components that can be included in such a processor system 110 and/or devices that can be in communication with a processor system 110, and that elements can be removed or additional elements can be added depending upon the desired functionality of such a system. For example, the processor system 110 can function independently of a network 150, or can include more or fewer components than illustrated in FIG. 1.

The processor system 110 illustrated in FIG. 1 can be, for example, a commercially available personal computer (PC), a workstation, a network appliance, a portable electronic device, or a less-complex computing or processing device (e.g., a device that is dedicated to performing one or more specific tasks or other processor-based), or any other device capable of communicating via a network 150. Although each component of the processor system 110 is shown as a single component in FIG. 1, the processor system 110 can include multiple numbers of any components shown in FIG. 1. Additionally, multiple components of the processor system 110 can be combined as a single component, where desired.

The processor system 110 includes a processor 112, which can be a commercially available microprocessor capable of performing general processing operations. For example, the processor 112 can be selected from the 8086 family of central processing units (CPUs) available from Intel Corp. of Santa Clara, Calif., or other similar processors. Alternatively, the processor 112 can be an application-specific integrated circuit (ASIC), or a combination of ASICs, designed to achieve one or more specific functions, or enable one or more specific devices or applications. In yet another alternative, the processor 112 can be an analog or digital circuit, or a combination of multiple circuits.

The processor 112 can optionally include one or more individual sub-processors or coprocessors. For example, the processor 112 can include a graphics coprocessor that is capable of rendering graphics, a math coprocessor that is capable of efficiently performing mathematical calculations, a controller that is capable of controlling one or more devices, a sensor interface that is capable of receiving sensory input from one or more sensing devices, and so forth.

Additionally, the processor system 110 can include a controller (not shown), which can optionally form part of the processor 112, or be external thereto. A controller can, for example, be configured to control one or more devices associated with the processor system 110. For example, a controller can be used to control one or more devices integral to the processor system 110, such as input or output devices, sensors, or other devices. Additionally, or alternatively, a controller can be configured to control one or more devices external to the processor system 110, which can be accessed via an input/output (I/O) component 120 of the processor system 110, such as peripheral devices 130, devices accessed via a network 150, or the like.

The processor system 110 can also include a memory component 114. As shown in FIG. 1, the memory component 114 can include one or more types of memory. For example, the memory component 114 can include a read-only memory (ROM) component 114a and a random-access memory (RAM) component 114b. The memory component 114 can also include other types of memory not illustrated in FIG. 1 that are suitable for storing data in a form retrievable by the processor 112, and are capable of storing data written by the processor 112. For example, electronically programmable read only memory (EPROM), erasable electrically programmable read only memory (EEPROM), flash memory, as well as other suitable forms of memory can be included as part of the memory component 114. The processor 112 is in communication with the memory component 114, and can store data in the memory component 114 or retrieve data previously stored in the memory component 114.

The processor system 110 can also include a storage component 116, which can be one or more of a variety of different types of storage devices. For example, the storage component 116 can be a device similar to the memory component 114 (e.g., EPROM, EEPROM, flash memory, etc.). Additionally, or alternatively, the storage component 116 can be a magnetic storage device, such as a disk drive, a hard-disk drive, compact-disk (CD) drive, database component, or the like. In other words, the storage component 116 can be any type of storage device suitable for storing data in a format accessible to the processor system 110.

The various components of the processor system 110 can communicate with one another via a bus 118, which is capable of carrying instructions from the processor 112 to other components, and which is capable of carrying data between the various components of the processor system 110. Data retrieved from or written to the memory component 114 and/or the storage component 116 can also be communicated via the bus 118.

The processor system 110 and its components can communicate with devices external to the processor system 110 by way of an input/output (I/O) component 120 (accessed via the bus 118). According one or more embodiments of the invention, the I/O component 120 can communicate using a variety of suitable communication interfaces. The I/O component 120 can also include, for example, wireless connections, such as infrared ports, optical ports, Bluetooth wireless ports, wireless LAN ports, or the like. Additionally, the I/O component 120 can include wired connections, such as standard serial ports, parallel ports, universal serial bus (USB) ports, S-video ports, large area network (LAN) ports, small computer system interface (SCSI) ports, and so forth.

By way of the I/O component 120 the processor system 110 can communicate with devices external to the processor system 110, such as peripheral devices 130 that are local to the processor system 110, or with devices that are remote to the processor system 110 (e.g., via the network 150). The I/O component 120 can be configured to communicate using one or more communications protocols used for communicating with devices, such as the peripheral devices 130. The peripheral devices 130 in communication with the processor system 110 can include any of a number of peripheral devices 130 desirable to be accessed by or used in conjunction with the processor system 110. For example, the peripheral devices 130 with which the processor system 110 can communicate via the I/O component 120, can include a communications component, processor, a memory component, a printer, a scanner, a storage component (e.g., an external disk drive, database, etc.), or any other device desirable to be connected to the processor system 110.

The processor system 110 can communicate with a network 150, such as the Internet or other networks by way of a gateway, a point of presence (POP) (not shown), or other suitable means. Work center manager 165, executing on processor system 110, can provide access by users 145 to one or more work centers 160. Each work center 160 can be owned or administered by a different entity, with centralized access control and other functionality being controlled by work center manager 165. Work center manager 165 can be provided via any network-based functionality including, for example, an application service provider (ASP) environment or via a web services approach.

Work center manager 165 can include numerous types of functionality, including, without limitation, multi-center routing module 170, electronic signature processing module 175, audio or web conferencing module 177, document management module 179, task management 181, calendaring 183, secure communications 185, forms management 187. In addition, any other types of electronically-enabled work flow could be included in work center manager 165.

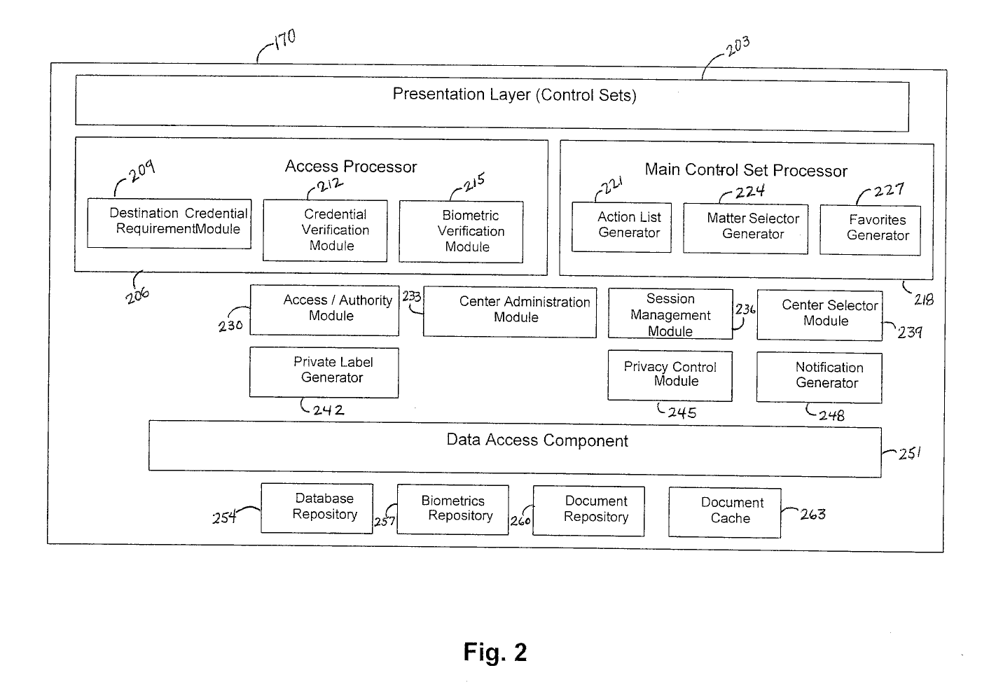

FIG. 2 is a functional block diagram of an embodiment of multi-center routing module 170 shown in FIG. 1 as part of work center manager 165. The components of work center module 165 can include processors (which can consist of multiple modules and generators with a specific function to complete), modules (which can consist of discrete program functions and sub-routines that have small tasks to complete and return control back to the overall application), and generators (which can produce output for the user). Multi-center routing refers to the provisioning and management of multiple work centers for a single user of processor system 110. Multi-center routing module 170 contains several modules used to provide the multi-center routing functionality described in further detail below.

As show in FIG. 2, presentation layer 203 enables the various components of each work center 160 to be displayed to the user of processor system 110. Presentation layer 203 provides for the delivery and formatting of information to the application layer for further processing or display and can consist of any well known techniques for displaying content to users, including the well known hyper text transfer protocol (HTTP) used for displaying information over the World Wide Web (or just web).

In an embodiment, access processor 206 and main control set processor 218 can combine to provide the main functionality for the multi-center routing. Whenever a user requests access to any part of a particular work center, access processor 206 can check the credentials of that user. Thus, access processor 206 can provide all functions needed to provide access to the services of each of the work centers 160. Such functions can be provided by destination credential requirements module 209, credential verification module 212, and biometric verification module 215.

Each work center 160 can contain different destination credential requirements for that particular work center. For example, a particular work center may require a particular level of authorization or may require a specific type of user credential. In an embodiment, credential requirements can be embedded in each destination within any given work center. A work center administrator can set particular users' credentials in such a way as to allow or deny access to specific destinations within the work center they administer. The destination credential requirements module 209 can access these requirements upon a request by a user to a destination and compare those requirements to the user's current set of credentials to ascertain whether to allow or deny access to a requested destination within a particular work center 160. For example, a signature job setup module may be one destination within a work center and may contain a credential requirement embedded in that web page requiring the user wishing to access this web page and initiate a signature job to have credentials of a manager of matters or projects within the work center as designated by a work center administrator.

In an embodiment, user credentials can comprise information bound to the particular user that can contain, amongst other things, the identity of the user, the access rights of the user, and cryptographic information unique to the user. For example, a user credential could consist of a well known X.509 certificate. In an alternative embodiment, a user credential could consist of a biometric template or a web login using a username and password combination. Each authentication method can utilize encrypted session or state containers (e.g., the well known cookies that can be used to temporarily or permanently store user information) to store the credentials for comparisons to destination requirements. Within work center manager 165, user credentials can be used for mapping the rights of the user into a hashed name/value array table used for later verifying the requirements of a particular work center against that user's access rights.

In an embodiment, a hash table could be used that contains multiple name and value pairs, where each name/value pair contains a user's credentials associated with a particular work center. As an example, a particular work center may utilize credentials for three different things: access to the work center, access to a particular matter within the work center (where a matter could be an arbitrary subject or topic chosen by an administrator of the work center), and access to a particular document within a specific matter. Thus, a hash table for such a work center could comprise: (a) a globally unique identifier (GUID) for the user of processor system 110, (b) a GUID for the chosen work center, (c) the authorization for that user within the chosen work center, (d) a GUID for the particular matter within the chosen work center, (e) the authorization level for that user for that matter, (f) a GUID for the current document within the matter, and (g) the authorization level for that user for that document.

Credential verification module 212 can be used to verify that the credentials of the user of processor system 110 meet the requirements of the destination within a work center 160 requested by the user. Upon determining the credential requirements of the destination within a work center 160, destination credential requirements module 209 can instantiate a call to credential verification module 212, which can then verify the credentials of the user against the requirements for the desired destination work center 160. If a particular work center requires biometric authentication, credential verification module 212 can optionally call biometric verification module 215 to verify any biometric authentication mechanism (including, without limitation, a thumb or fingerprint template, retinal scan, a facial recognition system, or a voice authentication system).

Credential verification module 212 can further utilize a session management module 236 to assist with the login process and to control the ability for a user to access work center resources based on credential expiration. For example, a particular work center may only allow a user to be idle for a limited amount of time while logged into the work center or while accessing a particular document. Session management module 236 can keep track of all credential expiration periods and can enforce those expiration, including via the use of time out warnings and closing of file or work center access by the user.

Main control set processor 218 contains the functions within the work center manager that provide the main multi-center routing capabilities. In an embodiment, main control set processor 218 will generate the main page of a work center chosen by a particular user. Main control set processor 218 can contain action list generator 221, matter selector generator 224, and favorites generator 227. Further, main control set processor 218 can utilize center selector module 239 to provide the user with the ability to select an active work center and notification generator 248 to collect and provide notifications to the user.

Action list generator 221 can receive input from multiple work centers about currently outstanding actions for a particular user. Actions could include, for example, outstanding requests to digitally sign a document or attend a conference. By way of example but not limitation, other actions could include a notice of receipt of a secure communication or web conference or a request to review and edit a document. The action list transcends the particular work center currently chosen by the user; that is, the action list will remain static for a particular user, regardless of the work center in which the user currently is working. For example, if a user changes from a work center of that user's employer to the work center of one of the employer's vendors, the action list will remain the same for that user and will still contain the list of outstanding actions for all work centers to which that user belongs.

Matter selector generator 224 can provide a tailored list of matters for a particular user, based on the authorized work centers and matters to which that user has access. Similarly, favorites generator 227 can cause a list to be displayed of user-selected locations and resources that the user would like to reference quickly (i.e., a favorites list). Like action list generator 221, favorites generator 227 is transcendent and will not change when the user changes from one work center to another.

Other functions available within work center manager 165 can be made available to matter managers or administrators for maintenance and administration of a given work center. For example, work center manager 165 can optionally provide the ability for an organization or other entity to “private label” a particular work center. Private label refers to the ability of that work center to appear as if it originated directly from the organization responsible for the work center. For example, if XYZ Corporation sets up a work center via an ASP that provides the overall work center functionality, information about the ASP would be minimal (or completely absent, depending on the private label approach utilized by the ASP). The prominent corporate information visible to the user would only be about XYZ Corporation. Thus, although the ASP is providing the service, the work center would appear to the end user as if it were solely the responsibility of XYZ Corporation. In order to provide this capability, work center manager 165 can contain private label generator 242, which would provide all private labeling or branding capabilities for the work centers.

Similarly, as discussed above, credential verification module 212 will utilize the credentials of the user to determine whether the user meets the requirements of the destination work center. In order to establish those credentials, a separate access/authority module 230 can allow an administrator or a matter manager to set the authority for each user for a particular matter and for each document within each matter. For example, a particular work center 160 might require a user to provide answers to a set of secret questions in order to authenticate that user. Access/authority module 230 can be used to collect those questions and answers and credential verification module 212 can be used to verify those questions and answers. In addition to secret questions, access/authority module 230 can provide the user the ability to select an image they wish to use to verify the identity of the application requesting their credentials. They would select an image that has meaning to them and would verify the same image is displayed on subsequent visits prior to providing their password or secret answers. This method can reduce attempted “phishing” schemes by hackers.

Likewise, a privacy control module 245 can be used by an administrator or matter manager to set privacy settings with respect to resources within the work center. In the work center rubric, the privacy settings are used to control what users can have access to what resources (e.g., documents) within a work center. For example, a matter manager responsible for purchasing could have a matter set up for all vendors with which that matter manager must interact, but via the privacy settings could prevent any of the vendors from having access to information about any of the other vendors. In fact, via the privacy settings, that purchasing matter manager could prevent each vendor from even knowing the identity of the other vendors.

Other functions available to matter managers and administrators can be controlled and accessed via work center administration module 233, which can, for example, provide the ability to add new users. The matter manager or administrator could also use work center administration module 233 to control groupings of users, categorization of matters, and for instantiating the call to private label generator 242.

Each of the processors, generators, and modules described with respect to FIG. 2 can utilize data access component 251 to handle all data flows from the various repositories in the system. Each of the repositories can be implemented using a variety of techniques, including, without limitation, Active Directory, New Technology File System (NTFS), File Allocation Table (FAT), or any other file management approach. By way of example and not limitation, database repository 254 can contain all data used to manage the overall system, such as credentials, selected options, user information, private labeling data, work center options and billing information, matter and document categorizations, matter and document details, document revision history, and audit trail information. Similarly, biometrics repository 257 can contain all information needed for implementing biometrics in work center manager 165, including, without limitation, templates and other biometric data. Document repository 260 can contain all documents for the users of each work center 160 in the system. Finally, a document cache 263 can be included to optimize access for frequently accessed documents.

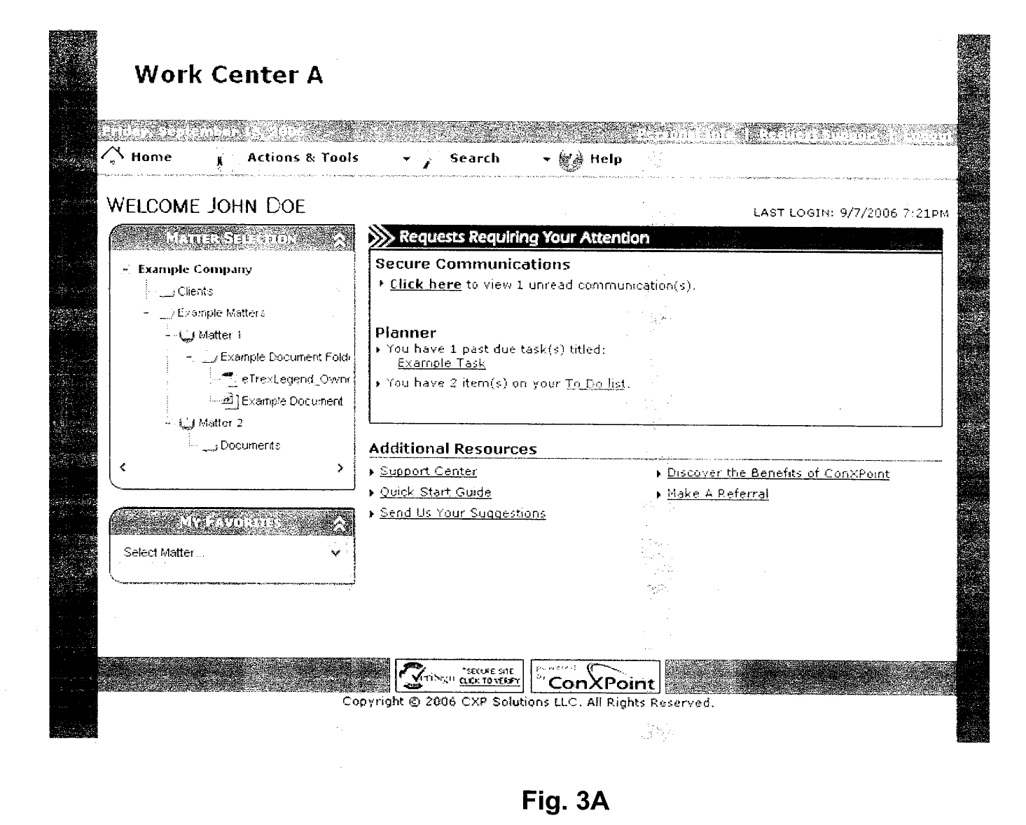

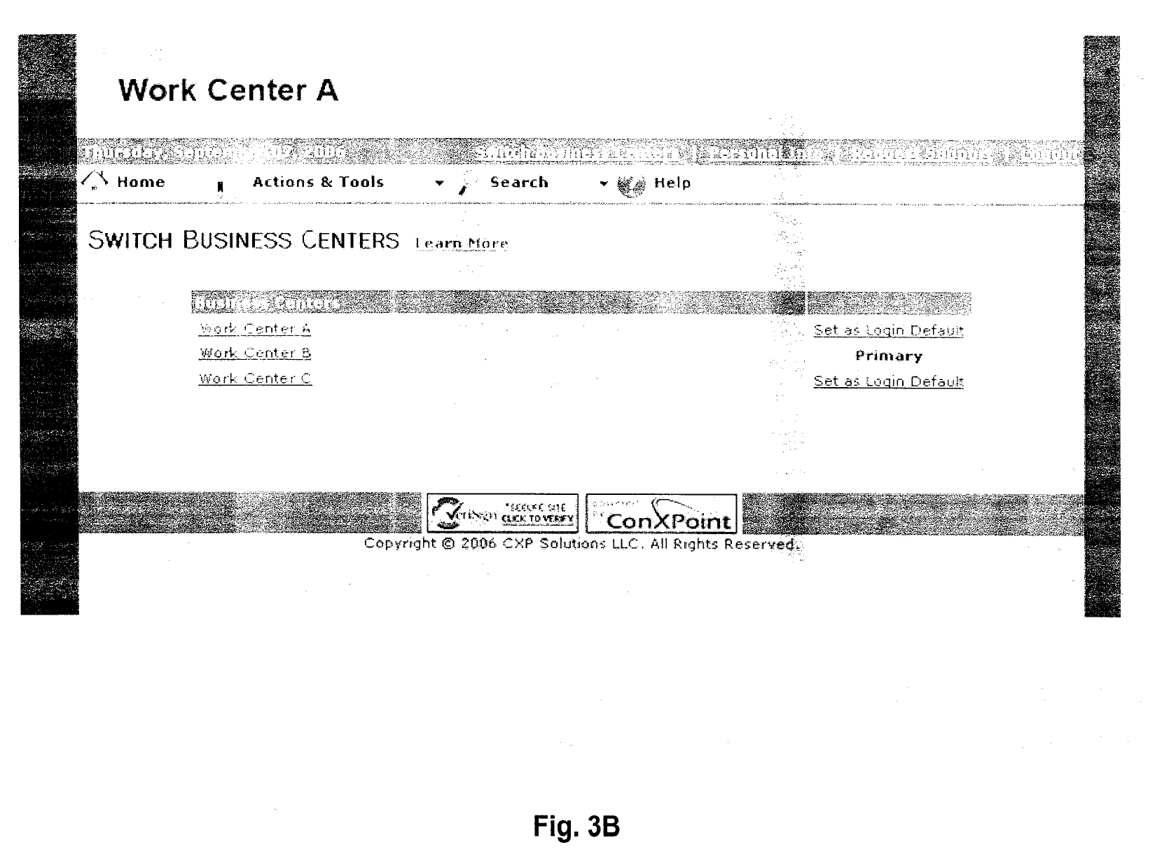

FIG. 3A depicts a screenshot of one embodiment of the main work center page for a user connected via work center manager 165 to one work center 160. As shown in FIG. 3A, the user can have access to requested actions (or “to dos”) and access to the user's “Favorites,” both of which are transcendent across work centers. Also in this embodiment, the user can select from various project/matters and documents available to the user within the work center in which the user is working, and then by clicking on the Actions/Tools dropdown in the upper tool bar, the user can access various types of functionality to use in performing work on the various matters and documents. When the user completes the work needed in this work center, the user may log out or switch to another work center. To switch to another work center, the user can click on the Switch Business Centers link in the upper tool bar. This link can take the user to FIG. 3B which is a screenshot of a web page providing a list of the work centers to which the user has been granted access by the respective work center owner/administrator/managers. On the web page show in FIG. 3B, the user can designate any one of the listed work centers as Primary which means that when the user logs into the work center system, the user's primary home page will show up in the designated Primary work center. Also, from the web page shown in FIG. 3B, the user can access any of the other work centers to which the user has access simply by double clicking on the name of the desired work center. This action will cause the Access Processor 206 in multi-center routing module 170 to compare the user's credentials with the access requirements of the requested work center and the multi-center routing module 170 to re-create the user's primary home page in the form compatible with the requested work center and provide the user with access to the requested work center.

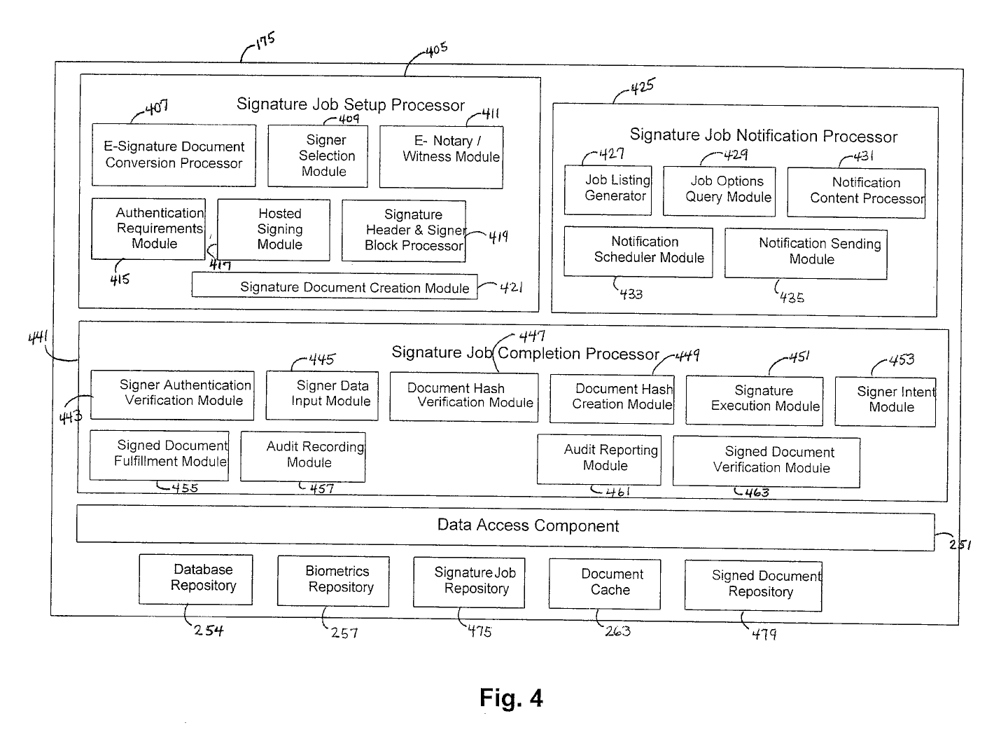

FIG. 4 is a functional block diagram of an embodiment of electronic signature processing module 175 shown in FIG. 1 as part of work center manager 165. An electronic signature can be defined as any sound, symbol, or process attached to or logically associated with an electronic data object and executed or adopted by a user with the intent to sign the record. An electronic signature can be associated with any type of data object. A data object can include any collection of electronic content or information, including, for example, an electronic record, a data file, a message, an audio file, a document file, a video stream, or any other defined collection of electronic information.

An electronic signature can include a public key digital signature (or simply digital signature), which can be calculated across any data object using well understood cryptographic techniques. A digital signature derives its security from the concept of a key pair, consisting of a public key and private key that have a specific mathematical relationship between them. Within a public key infrastructure (PKI), a Certification Authority (CA) can provide each user with a key pair. In a PKI, the public key of a user can be shared publicly without jeopardizing overall security. More specifically, the mathematical relationship between the public key and the private key that comprise the key pair permit a user of the key pair to reveal the public key such that the user can communicate with others within the PKI but any entity that obtains the user's public key cannot compromise the communications of that user or any other users. This characteristic is particularly important in an open network system such as the Internet where parties that are unknown to each other need a reliable means of authenticating each other. The private key, on the other hand, must be securely maintained in order for the security of the system to be maintained.

A public key pair used to produce a public key digital signature further has the property of computational infeasibility; i.e., it would be computationally infeasible for an entity to determine the private key of a user from the public key of that user. Thus, the user may share the public key of the user's key pair through a mechanism known as a digital certificate (or simply a “certificate”). In addition to the public key, a certificate may contain a number of other fields that contain information about the user or about the CA that issued the certificate. The well understood X.509 standard, ITU recommendation ITU-T X.509, defines a certificate format commonly used for Internet communications.

The mathematical relationship between the private key that produces the digital signature and the public key that verifies the digital signature provides several important security services. First, authentication provides the assurance to the person receiving and verifying the digital signature that the signature was in fact produced by someone who had access to the private key associated with the public key that was used to verify that digital signature.

The second security service provided via the use of digital signatures is known as data integrity. This security service provides the assurance that the message that was created by the signer of the electronic record has not been changed in the course of its transmission to the receiver of that electronic record. Operationally, the assurance of data integrity comes from the mathematical processes used to produce and verify the digital signature. One portion of the digital signature process consists of calculating a hash result or hash value from a one way hashing function. The one way hashing function is applied to every portion of the data object that is going to be signed by the signer. The hashing function produces a unique value for each message that is then used as the input to the actual production of the digital signature. The hash value thus produced ensures that if any bit in the message or electronic record that is being digitally signed is changed, the verification of the digital signature will fail.

The third security service offered by the use of digital signatures is known as nonrepudiation. Nonrepudiation refers to the assurance to the recipient of a digitally signed message that evidence exists that would make it extremely difficult for the signer of that message to later deny having sent that message. Thus, the service of nonrepudiation offered by digital signatures is an evidentiary assurance. There are situations, however, when a signer of a message may not have had the intent to authenticate that message. Some examples of these situations include duress (e.g., a person being forced to sign something that he or she does not want to sign), loss of control of the private key that was used to produce the digital signature, and scenarios where the signer of the message claims that either (a) what they signed was not what was displayed to them or (b) what was presented to them for signature was not in fact what they digitally signed.

Electronic signature processing module 175 can contain signature job setup processor 405 for preparing a document for signature and creating the necessary tasks associated with the signing requirements of the user. In an embodiment, the electronic signature process described herein can include application to a document of both an electronic representation of a handwritten signature and a cryptographic digital signature (as described above).

Electronic signature processing module 175 can also contain signature job notification processor 425 for providing the necessary notifications to each participant within the system that will be involved in a particular document signing process. Electronic signature processing module 175 can further contain signature job completion processor 441 for completing the document signing process that had been initiated by the user via signature job setup processor 405. Signature job completion processor 441 can utilize either a PKI methodology or an identification verification methodology (for example a personal identification number (PIN) or biometric identifier). If PKI is utilized, the users' certificate can be utilized in the hashing of the document. If identification verification is utilized, hashing of the document is done with the certificate assigned to the server.

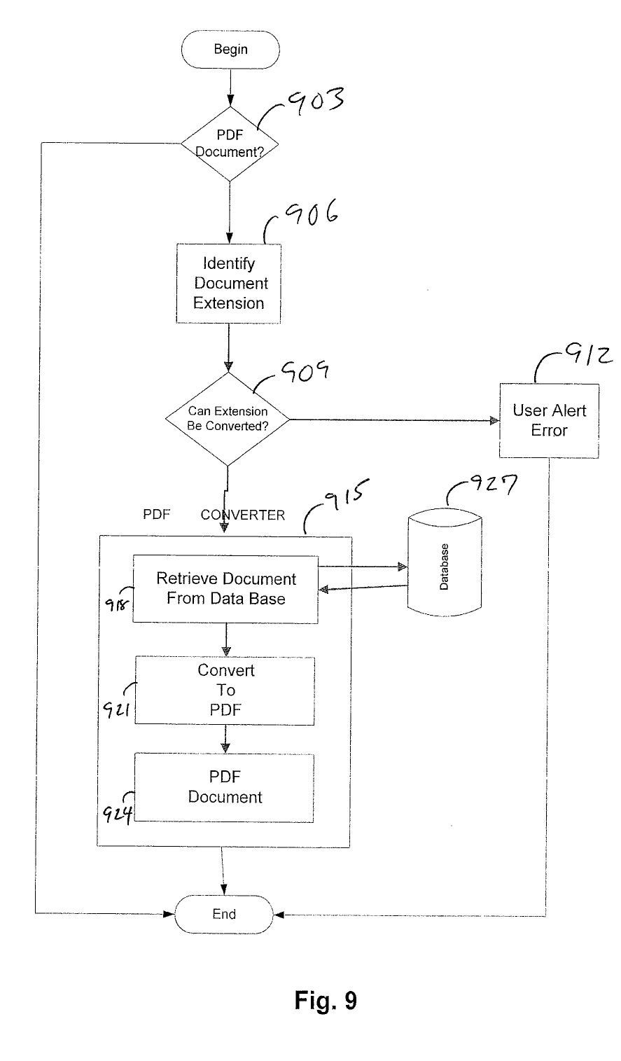

Signature job setup processor 405 can contain a number of different modules utilized for initiating a document signing process. E-signature document conversion processor 407 can be utilized to convert a document from any of a variety of formats into a common document format, such as, in an embodiment, a PDF document (where PDF refers to the well understood Portable Document Format of Adobe, Inc.) Further detail on this process will be given with respect to FIG. 9. Signer selection module 409 can be used to add both registered and non-registered users to the list of signers of the document to be signed.

Other modules in signature job setup processor 405 can include E-Notary/Witness Module 411, which can be utilized to facilitate the activities related to electronic notarization and/or witnessing of electronic signatures, including, for example, the addition of jurisdiction-specific information into the document related to notaries and witnesses. Authentication requirements module 415 handles all processing related to collecting requirements for different authentication options required to apply electronic signatures (including, for example, biometric authentication and PKI).

Hosted signing module 417 can facilitate the hosting of a signature event by one person that will allow one or more other people to electronically sign a document. For example, the signers of an electronic object in a specific geographic location can be assigned to a particular host for the signature event at that location. Also, a determination can be made as to whether the host or signature job originator will be personally contacting the signers or if work center manager 165 will be notifying the signers. Also, there can be instances of where the host will also act as a witness, but, for security purposes, this could be disallowed if the host is also a signer (in order to reduce fraudulent use of the system).

Signature headers and signer block processor 419 can be utilized to instantiate the signing blocks for each of the signers. A signing block can consist of an area of a document that will contain an electronic representation of a signature along with the information for each signer as stipulated by the signature job originator during the signature job setup 405. Additionally, a signature job originator can create custom headers along with E-Notary and witness page preambles utilizing signature headers and signer block processor 419.

The signature document creation module 421 can collect the various pieces described above that will make up the document and integrate them into a single monolithic document. This is also known as “stitching” the document together. Once all pieces have been integrated into a single PDF document, signature document creation module 421 can calculate (or have calculated by a separate third party service) a hash value on the document. In an embodiment, this calculation of this hash value can include the Secure Hash Algorithm (SHA-1 or SHA-256). Once the complete document has been created and a hash value calculated, signature document creation module 421 can initiate the actual document signing process. In an embodiment, the signing process can be accomplished utilizing functionality available within work center manager 165. Alternatively, a third party service could be used to implement the electronic signature process.

As briefly described above, signature job notification processor 425 can provide the necessary notifications to each participant within the system that will be involved in a particular document signing process. Accordingly, signature job notification processor 425 can include a job listing generator 427 for collecting information on all outstanding or incomplete signature jobs from the various work centers and collate those outstanding signature jobs. Job options query module 429 can then initiate queries to determine the tasks still to be completed for each outstanding or incomplete job. For example, job options query module 429 can query a work center as to whether a particular signer has signed a given document or whether and when a notification was sent to the signer or a responsible matter manager.

Notification content processor 431 within signature job notification processor 425 can handle tasks associated with transmitting the correct content to a particular recipient (based on the signer's identity and the results from the queries generated by job options query module 429. Signature job notification processor 425 can further use notification scheduler module 433 and notification sending module 435 to actually perform the process of scheduling and transmitting notifications regarding outstanding tasks associated with any incomplete signature jobs.

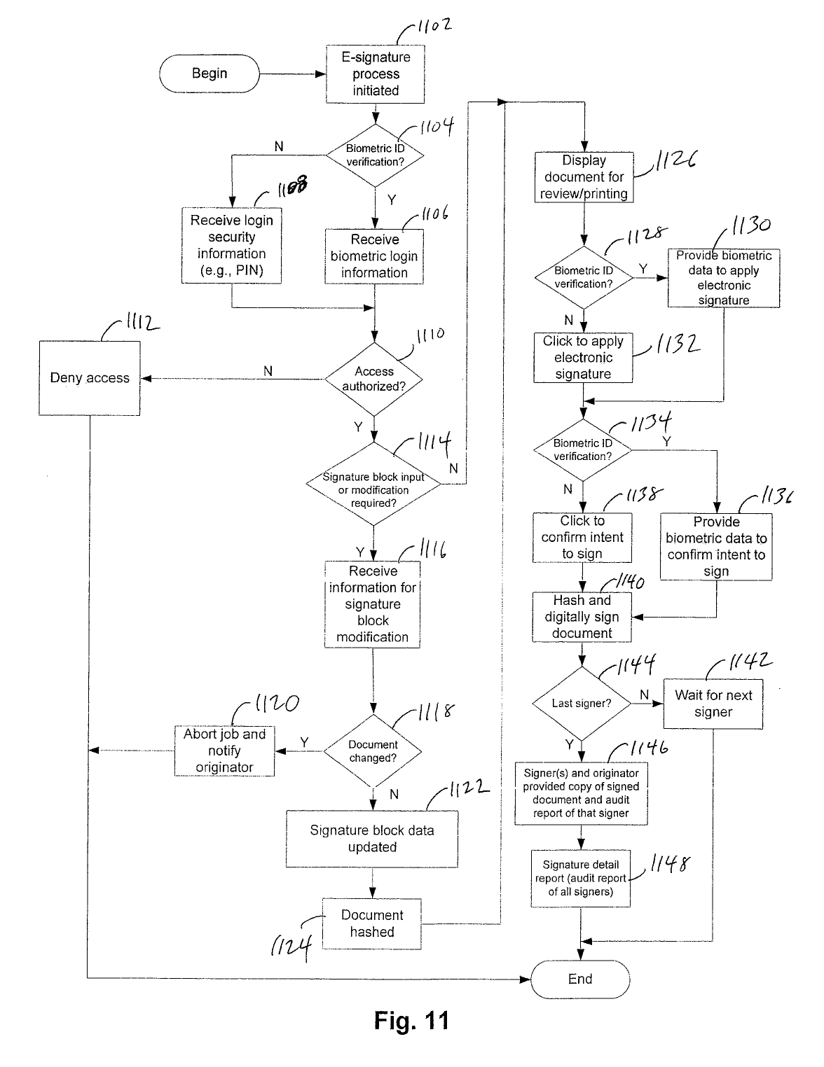

As described above, electronic signature processing module 175 can contain signature job completion processor 441 for completing a document signing process that may have been initiated by the user via signature job setup processor 405. The document signing completion process is further detailed in FIG. 11. In order to complete a signature job, signature job completion processor 441 can utilize several modules for performing different tasks.

Signer authentication verification module 443 within signature job completion processor 441 can perform the authentication activities required to meet the authentication requirements that were specified via authentication requirements module 415. Signer data input module 445 can be used to collect information from the user (including, for example, birth date, address, and any other information required by the work center or by the notary). Document hash verification module 447 can be utilized to check the hash calculated on the document by signature document creation module 421. This can be used to ensure that no modifications to the document have taken place since it was integrated by signature job setup processor 405. In the event that additional signer input is received via signer data input module 445 or if any additional changes to the document are required, an updated hash value on the document will be required and can be calculated by document hash creation module 449.

In an embodiment, a signer can place an electronic representation of the signer's handwritten signature into the document being signed. Signature execution module 451 can prompt the signer to apply this electronic representation into the document. Such a prompt could consist, for example, of a computer click in a dialog box. In an alternative embodiment, a signer could be prompted to submit biometric information (e.g., a fingerprint or retinal scan). Similarly, a user could also be prompted to signify the signer's intent regarding the application of the signer's signature to the document. Signer intent module 453 can prompt the signer to signify intent regarding the signature on the document. As with signature execution module 451, such a prompt could consist, for example, of a computer click in a dialog box. In an alternative embodiment, a signer could be prompted to submit biometric information (e.g., a fingerprint or retinal scan).

Once the actual signing of the document has been completed (via signature execution module 451 and signer intent module 453), signed document fulfillment module 455 can be utilized to collect information on what happened in the process of applying the electronic signature and acquiring the intent of the signer. Such information can be stored in signature job repository 475. Also, if the overall document signature process is complete (e.g., if all required signers have signed the document), signed document fulfillment module 455 can notify the signer(s) and the signature job originator. Signed document fulfillment module 455 can utilize data access component 251 to store the signed document (upon completion of the overall signing process) in signed document repository 479.

In order to provide evidence related to the signed document, audit recording module 457 can be used to record data from the various portions of the process. For example, the secret questions used in the authentication process described earlier can be recorded, along with PKI information, IP address of computer where signing took place, timestamps of when users were notified, when each user opened the document, when signature execution occurred, when signature commitment occurred, and when the signed document was received by all participants. Audit reporting module 461 can be used to display the audit information collected by audit recording module 457. This could occur upon completion of the signing process, along with subsequent verifications of signed documents that could be performed by signed document verification module 463. Document verification module 463 can be used to produce a server-based report of successful verifications of signed documents. In an alternate embodiment, that report could also be incorporated within the actual signed PDF document.

Various data repositories can be used in the functioning of electronic signature processing module 175, including database repository 254, biometrics repository 257, signed job repository 475 (described above), document cache 263, and signed document repository 479.

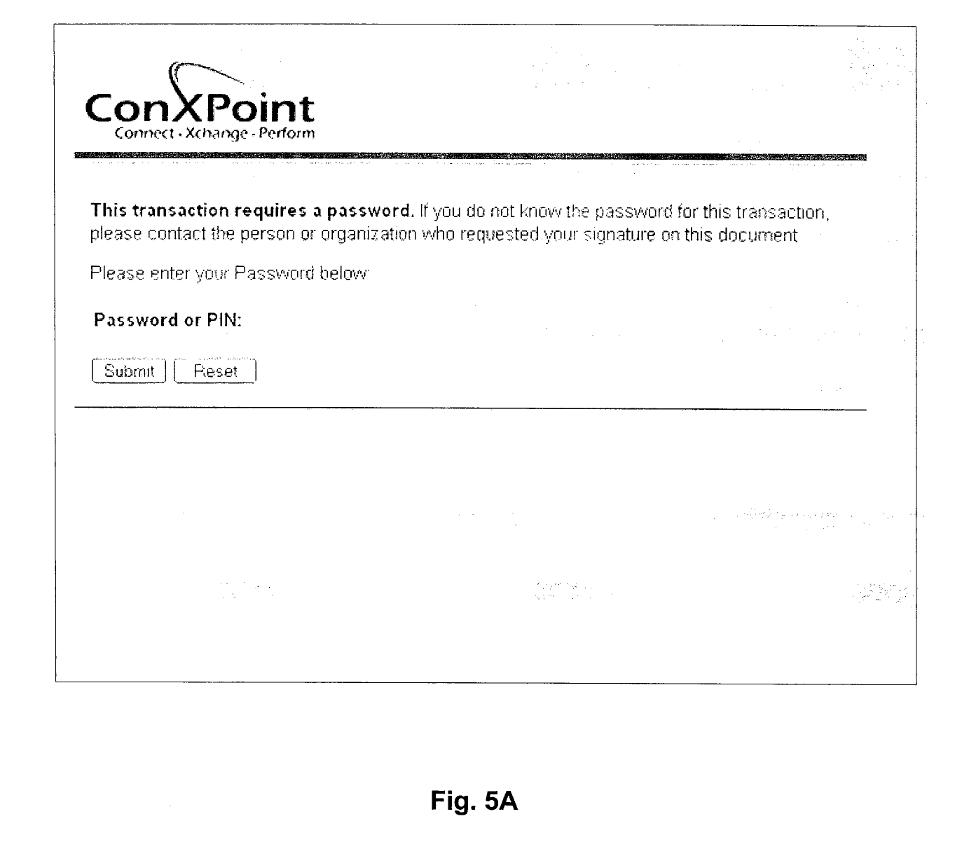

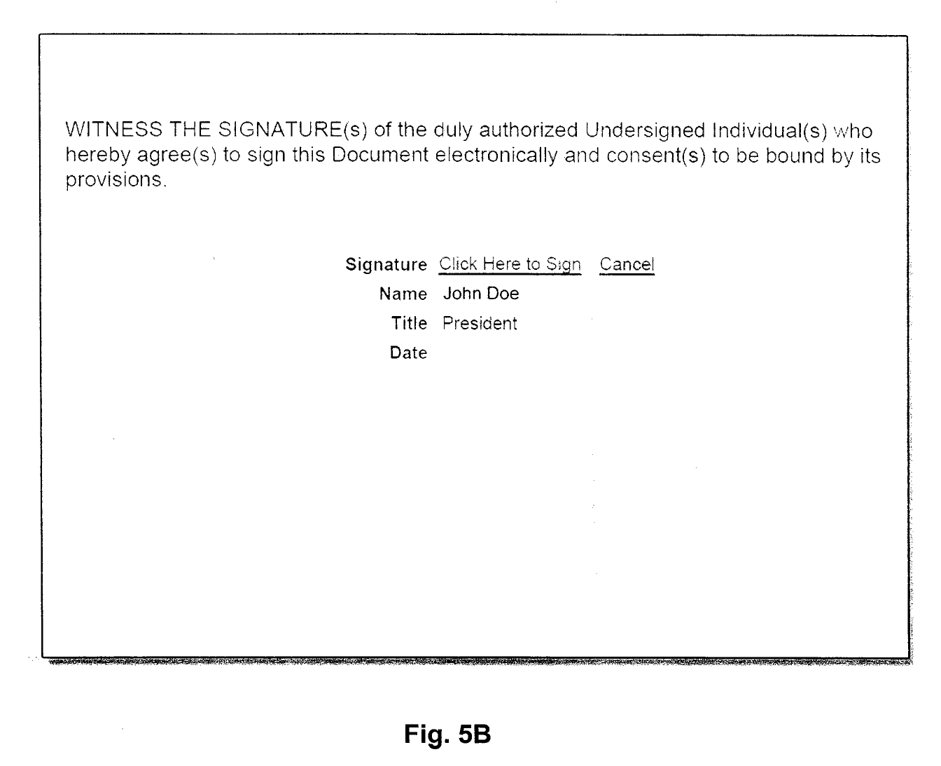

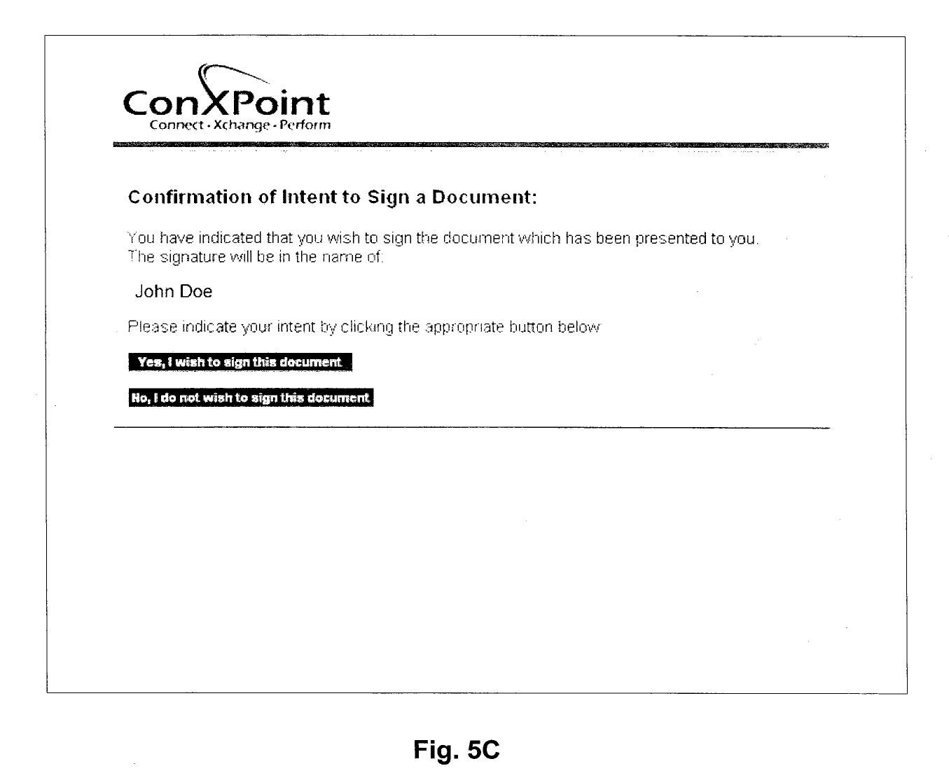

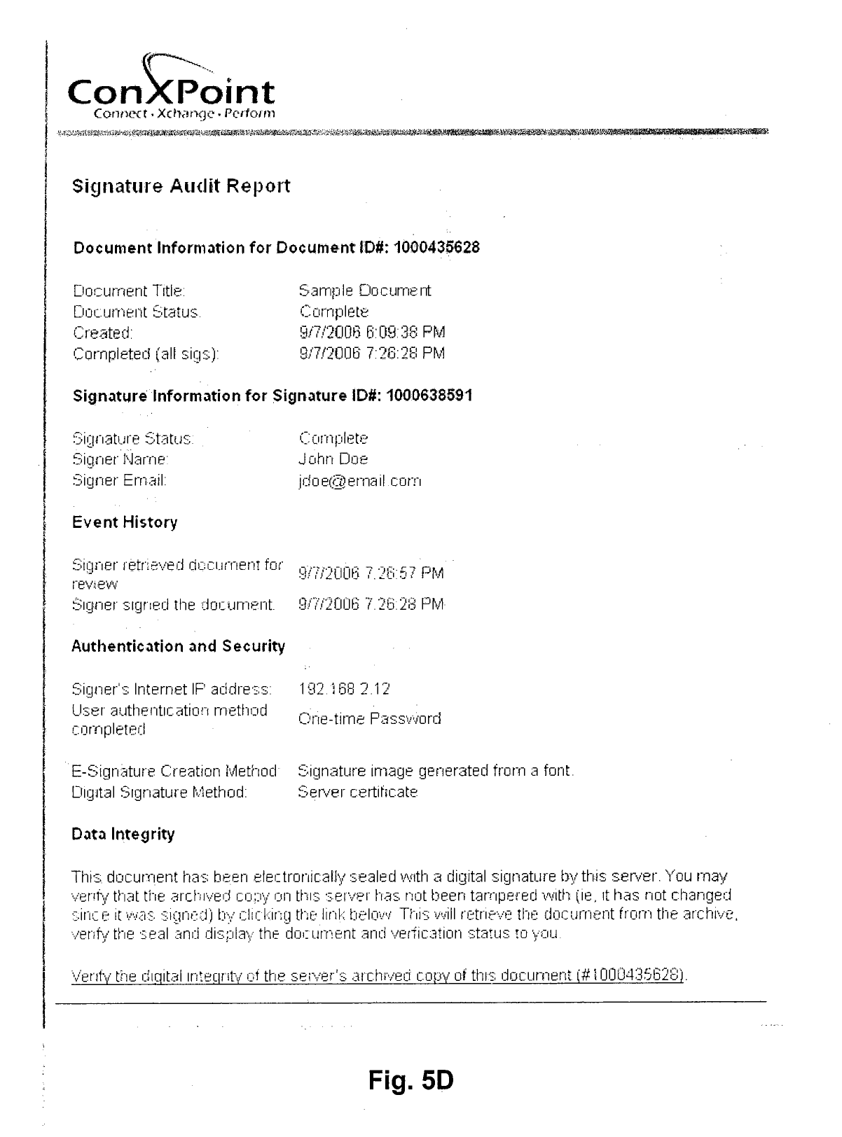

FIG. 5A through FIG. 5D show screen shots that could be presented to a user during the process of digitally signing a document, in an embodiment. FIG. 5A depicts a web page that could be presented to a user in connection with beginning the document signing process described above. As shown in FIG. 5A, a user can first be presented with a prompt for a password or PIN prior to beginning the document signature process. FIG. 5B shows what can be presented to a user upon the user having been authenticated to the system. In FIG. 5B, the user can be presented with a prompt that will cause an electronic signature to be applied to a document. By clicking on the link “Click here to sign”, the user will cause his or her electronic signature to be applied to the document. In FIG. 5C, the user can be presented with a prompt to confirm the intent of the signer in signing the document. FIG. 5D depicts an audit report that can be produced once a user has completed the electronic signature process.

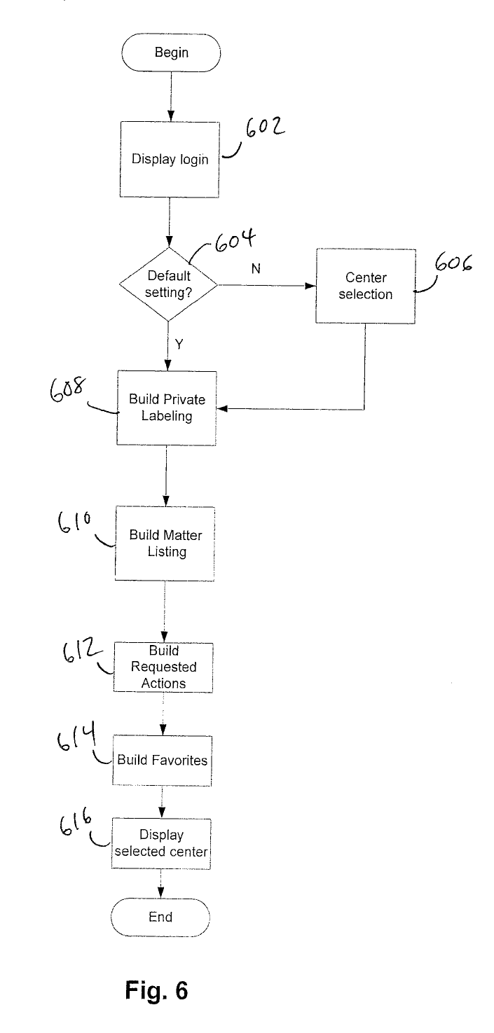

FIG. 6 depicts the process of building the multi-center routing main page for a user, according to an embodiment of the invention. In a step 602, a login screen can be displayed to the user. The login screen can contain basic information about the services available, along with an area to allow the user to enter login information (such as a username and password). Based on the login of the user, a determination can be made in a step 604 as to whether that particular user has already established a default setting. A default setting can include, for example, an initial work center in which the user wishes to begin all activity. If no default setting exists for the user, the user can select a preferred work center in a step 606.

Once the applicable work center for the user has been determined, private labeling of the work center can occur in a step 608. As discussed above regarding private label generator 242, private labeling refers to the tailoring of the information presented to the user about the work center, such that the work center appears to be owned or administered by a different entity than the entity actually operating work center manager 165. Once any required private labeling for the user has been performed, a matter listing can be built in a step 610 and a requested action list can be built in a step 612. If any favorites have been chosen by the user, a list of those favorites can be built in a step 614. Once all of the components of the selected work center have been generated as described above, the complete selected work center can be displayed to the user in a step 616.

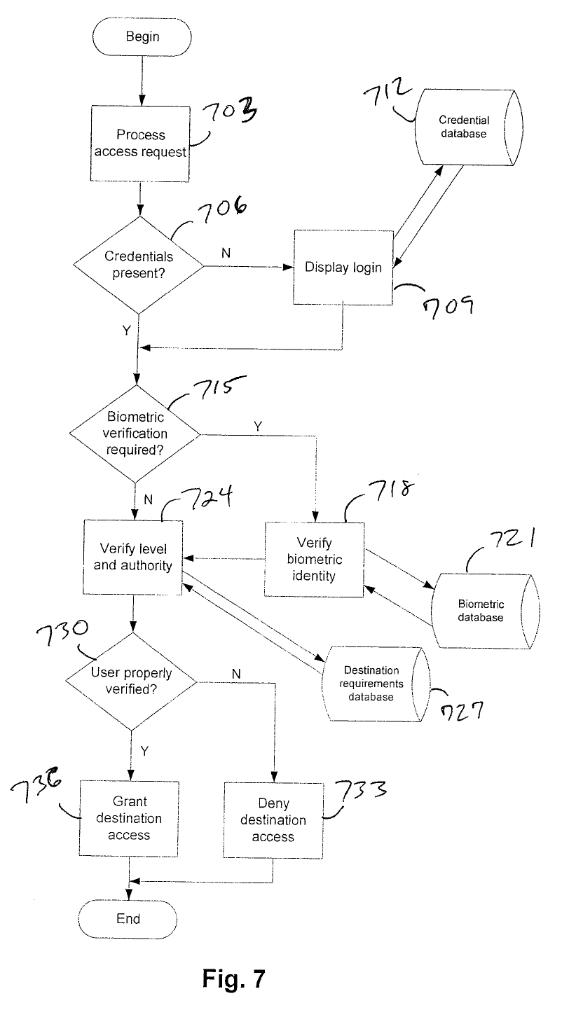

FIG. 7 depicts the process of verifying the level of authority and access for a user, according to an embodiment of the invention. The verification process begins with initial processing on the access request in a step 703. This can include, for example, a determination of whether the access request itself is valid and a comparison of the credential requirements embedded in the process for which access has been requested with the credentials of the user 706. An example of a process access request would be a user clicking to request access to the Signature Job Setup Processor 405. In a step 706, a determination can be made of whether the user has presented credentials to work center manager 165. If no credentials have been provided, a login can be displayed in a step 709, otherwise control can pass to a step 715. In an embodiment, a login could consist of a prompt for a username and password combination, which can be checked against a credential database 712. In step 715, a determination can be made of whether the particular work center requires biometric verification. If so, a verification of biometric identity (via biometric information presented by the user) can occur in a step 718 utilizing biometric information contained in biometric database 721. Biometric verification can work in conjunction with authority verification in step 724 to ascertain whether the user should be allowed access to the desired resource or not based on their authority. If the verification in step 718 or step 724 fail, the system would fail over to a step 733. Verification, therefore, can be made up of two components: (1) whether the user has the credentials to access the requested web page or process, and (2) whether the user has the authority credential to see or do the desired action once they have access.

Once the user has logged in and presented any required biometric information, the authority of the user can be verified in a step 724. This can consist of checking what resources the user is permitted to access within that particular work center. In a step 730, a determination can be made of whether the user has been properly verified for the selected work center. If so, the user can be granted access in a step 736. Otherwise, the user can be denied access in a step 733.

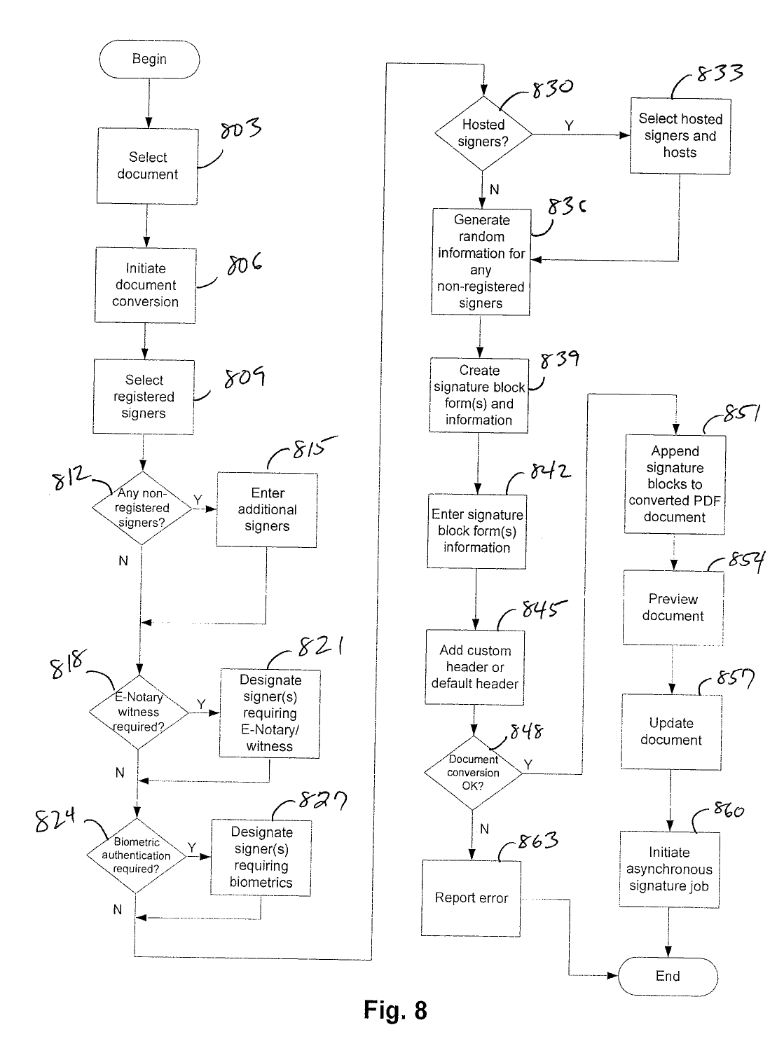

FIG. 8 depicts the process of initiating a digital signature process for a user, according to an embodiment of the invention. In a step 803, a document to be signed can be selected by the user. In a step 806, the process of converting the document into a compatible format can be initiated. FIG. 9 contains further detail on the document conversion process. In a step 809, any registered signers of the document are selected. Registered signers are those who have credentials that can be checked by work center manager 165 (i.e., users who have been added by a matter manager or administrator of the work center). A determination is made at a step 812 of whether any non-registered signers are required to sign the document. In contrast to registered signers, non-registered signers are those who are not affiliated with the current work center. In the event that there are non-registered signers, those non-registered signers can be entered in a step 815.

In a step 818, a determination is made of whether any E-Notaries or witnesses are required for the application of the signatures. If so, those signers required to have notarization or a witness are designated in a step 821. Similarly, in a step 824, a determination is made of whether any biometric authentication is required for any signers. If so, those signers required to have biometric data collected are designated in a step 827. Otherwise control passes to a step 830, where a determination is made of whether any hosted signers are required to sign the document. If so, the hosted signers and their respective hosts are selected in a step 833.

In a step 836, random data for any non-registered signers is generated. This random data can be utilized to authenticate the identity of each non-registered signer (i.e., it is analogous to a personal identification number (or PIN) for each non-registered user). In a step 839, a signature block form is created and in a step 842 information on each of the signers can be entered in the signature block form (i.e., the signature block form contains the signature blocks for each signer of the document). The originator can complete the signature block information or request the user complete information as part of the signature job completion process. In a step 845 any custom header information or any default headers can be added to the signature block form.

At this point, all necessary preparations to the signature block form have been made. Thus, in a step 848 a check is made to determine if the document conversion initiated in step 806 has completed successfully. If not, an error can be reported in a step 863 and the process can terminate with no signatures having been applied to the document. If successful, however, the signature blocks can be appended to the converted PDF document in a step 851. Once the signature blocks have been appended to the document, the document will be ready for signatures to be applied. Prior to the actual signature application process that involves all of the document signers, the document can be presented to the user for preview in a step 854. In the event that the user wishes to make any updates to the document, those updates can be made in step 857. This could occur, for example, via a wizard with “back” and “next” buttons that can allow the user to go to any point in the process to make changes. Upon the completion of any requested updates, the actual signature process (or signature job, as depicted in further detail in FIG. 11) can be initiated. Because of the fact that the signature process can involve different signers that may be signing the document at different times, the signature job can be initiated as an asynchronous process in a step 860.

FIG. 9 depicts the conversion of a document into a PDF document, according to an embodiment of the invention and as discussed above with respect to e-signature document conversion processor 407 in FIG. 4. In a step 903, an initial determination is made of whether the document to be signed is already in a form that can be signed (e.g., PDF, in an embodiment). If so, no further action is necessary and the process terminates. If the document is not in PDF form, the type of document can be determined based on the document extension in a step 906. Next, a determination is made in a step 909 of whether a document of the type corresponding to the extension determined in step 906 can be converted. If not, an error can be displayed or sent to the user in a step 912.

If the document can be converted to PDF, the document is passed to PDF document converter 915, which can perform the steps of retrieving the document from a document database 927, converting the document to PDF in a step 921, then returning the document in a step 924.

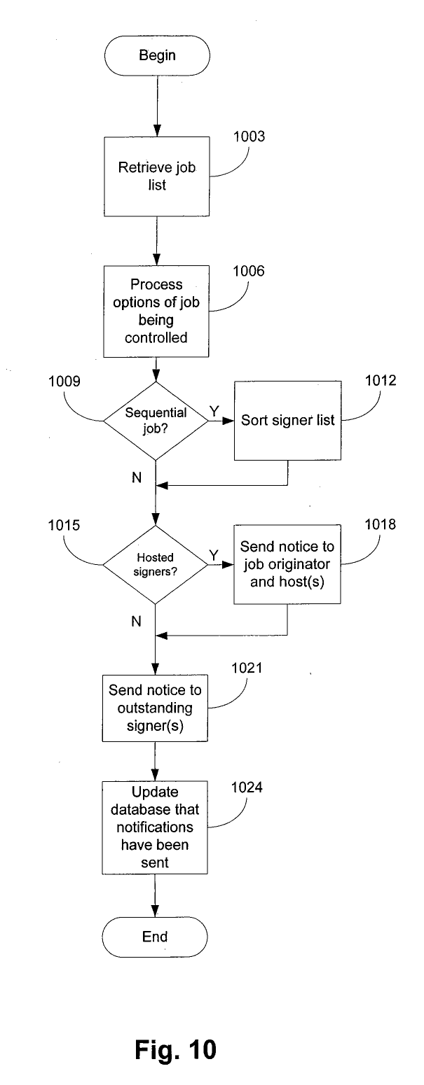

FIG. 10 is a flow chart depicting the notification of outstanding document signers, according to an embodiment of the invention. In a step 1003, a job list can be retrieved that contains all outstanding requirements for the document to be signed. In a step 1006, the options for the current signature job can be processed. Examples of these options may include checking if the signer: (a) has signed, (b) has been notified to sign in a specified time period, (c) been notified a certain number of times to sign, (d) is a remote signer, (e) is a host, is a hosted signer, (f) is a witness or e-notary, and (g) is if this is a sequential job. In a step 1009, a determination can be made if the signatures on the document need to be signed in a particular order (i.e., in a particular sequence). If so, the signer list can be sorted in a step 1012. Otherwise, a determination can next be made in a step 1015 of whether any hosted signers will be signing the document. If so, a notice can be sent in a step 1018 to the signature job originator and the one or more hosts that will be hosting signers. In a step 1021 electronic notices regarding outstanding signers can be sent to those outstanding signers, along with the signature job originator. Finally, in a step 1024, a database can be updated with the indication that notifications have been sent to the appropriate parties.

FIG. 11 is a flow chart that depicts the process of completing a digital signature process for a user, according to an embodiment of the invention. At a step 1102 an E-signature process can be initiated. This can occur upon the completion of the document preparation process described above with respect to FIG. 8. At a step 1104, a determination can be made of whether biometric verification of the signer is required. If so, the biometric login information on the signer can be received by the system in a step 1106. This could include any of the biometric data described earlier. If biometric verification is not required, other login information can be received by the system in a step 1108. At a step 1110, a determination can be made of whether access by the signer is permitted. For a registered user this can be accomplished by comparing the verification data collected in step 1106 or step 1108 against the information previously submitted when the signer first registered. For a non-registered user this can be accomplished by comparing the verification data collected in step 1108 to the random information assigned to the non-registered user in 836 of FIG. 8. If access is not authorized, the would-be signer can be denied access at a step 1112 and the process can terminate. If access is authorized, a determination can be made at a step 1114 of whether one or more of the signature blocks needs to be updated, whether via the addition of input from the signer or other modifications (for example the signer enters their job title, social security number, date of birth, or applies an image such as an e-notary seal). If the signature block does need modification, the additional information to be included can be received at a step 1116. At a step 1118, a determination can be made of whether the PDF document to be signed has been changed. This can be done by calculating a hash of the document and comparing against the hash that was calculated when the document was first assembled, as discussed above with respect to FIG. 8. If the document has been changed (i.e., tampered with), the signature job can be aborted and the originator can be notified in a step 1120, following which the process ends. If the document has not been changed, any necessary updates to the signature block can occur in a step 1122 as a result of collecting information in step 1116. Next, the document can be hashed again in a step 1124. This step is necessary since the content of the document will have been changed as a result of the signature block data being updated in step 1122.

If no signature block modification was necessary in the determination performed in step 1114 or upon completion of calculating the document hash, the document can be displayed for review or printing in a step 1126. This will provide the opportunity to the signer to verify the contents of the document. In a step 1128, a determination is made if biometric verification is required. If so, the appropriate biometric data can be collected to apply an electronic signature to the document (including, e.g., an electronic representation of a handwritten signature) in a step 1130. If biometric verification is not required, a signer can click to apply an electronic signature to the document in a step 1132. In a step 1134, a second determination can be made of whether biometric verification is required. If so, the appropriate biometric data can be collected in a step 1136 to confirm the signer's intent to sign the electronic document. If biometric verification is not required, a signer can click to confirm intent to sign the document at a step 1138.

Upon completion of confirming the intent of the signer to sign the document, the document can be hashed and digitally signed in a step 1140. This step can be used to create a cryptographic digital signature for the document. This digital signature provides authentication, data integrity, and evidence for nonrepudiation. Next, in a step 1144, a determination is made of whether the signer that just signed the document is the last signer of the document. If not, the process waits for the next signer in a step 1142. If it is the last signer, each signer of the document along with the originator of the document can be provided (for audit purposes, amongst other things) a copy of the signed document and an accompanying audit report of that signer in a step 1146. Then, in a step 1148, a signature detail report regarding all signers can be provided.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method of allowing access by a user to a work center for electronic collaboration, comprising:
receiving an access request from a user for access to a work center selected by the user, the selected work center being configured to specify credential requirements for each destination within the work center;
processing the access request within a work center manager, the work center manager being configured to analyze the access request against all known requirements for all work centers available to the user;
verifying that the user is authorized to perform activities associated with the access request in the selected work center; and
granting access to perform the activities associated with the access request in the selected work center upon verification of the authorization of the user.

2. A method as in claim 1, wherein said verifying further comprises:
prompting the user to provide credentials evidencing the right of the user to access the selected work center, if the user has not previously provided credentials to the work center manager;
receiving one or more credentials from the user;
checking the credentials presented by the user against a credential database; and
checking the resources available to the user in the selected work center.

3. A method for providing access by a user to an initial work center for electronic collaboration, comprising:
displaying a work center login screen to a user;
receiving login information from a user;
determining an initial work center to be displayed to the user following authentication of the user, the initial work center to be displayed being selected from one or more work centers available to the user;
performing tailoring of the initial work center;
building components of the work center particular to the user; and
displaying the initial work center to the user.

4. A method as in claim 3, wherein said one or more work centers further comprises a default work center.

5. A work center management system, comprising:
a processor system configured to communicate with at least one user over a computer network via an input/output component; and
a work center manager operatively connected to the processor system, the work center manager being configured to provide access by the at least one user based on a set of requirements associated with each work center, further comprising:
a multi-center routing module;
an electronic signature processing module;
an audio/web conference module;
a document management module;
a task management module;
a calendaring module;
a secure communications module; and
a forms management module.

6. A system for allowing a user to access multiple work centers from a single access point, comprising:
a presentation layer module;
an access processor;
a main control set processor;
one or more functional modules;
a data access component; and
one or more data repositories.

7. A method for initiating an asynchronous collaborative electronic signature process, comprising:
receiving a document signature request from a user, including a document to which one or more electronic signatures are to be applied;
determining whether to sign the document in its existing format;
if the document is not to be signed in its existing format, converting the document into a common format;
determining one or more individual signers required to apply an electronic signature to the selected document;
performing any required authentication of the one or more signers;
determining if any hosted signers are required to apply a hosted signer electronic signature to the selected document;
creating a signature block form;
appending one or more signature blocks to the converted document to create a prepared document; and
initiating an asynchronous electronic signature process for the prepared document.

8. The method of claim 7, further comprising:
presenting the prepared document to the user;
receiving instructions from the user that specify changes to be made to the prepared document; and
updating the prepared document according to the instructions received from the user.

9. The method of claim 7, wherein said converting further comprises:
initiating a remote document conversion process;
checking on the status of the remote document conversion process; and
receiving results from the remote document conversion process.

10. The method of claim 7, wherein said creating a signature block form further comprises:
receiving additional information from a signer;
adding the information from the signer to the signature block in the prepared document; and
adding a header to the signature block in the prepared document.

11. The method of claim 10, wherein said header further comprises a default header.

12. The method of claim 10, wherein said header further comprises a custom header.

13. The method of claim 7, wherein said creating a signature block form further comprises allowing the user to specify the location of an area within the document where information associated with one or more signers is to be placed.

14. The method of claim 13, wherein the information about the one or more signers comprises one or more initials of a signer.

15. A method for performing an asynchronous collaborative electronic signature process in a selected work center, comprising:
receiving an electronic signature request from an originator, wherein the originator requests that one or more users apply their electronic signature to a document selected by the originator;
prompting for credentials from a user, if the user has not previously provided credentials to the work center manager;
receiving one or more credentials from the user;
checking the credentials presented by the user against a credential database;
checking whether the user has been authorized to apply an electronic signature in the selected work center;
displaying a document for review by the user;
prompting the user to confirm generation of an electronic signature on the displayed document;
generating an electronic signature for the user to be applied to the displayed document, upon receipt of confirmation from the user to generate the electronic signature on the displayed document;
prompting the user to provide assent to the generated electronic signature to be applied to the displayed document;
applying the electronic signature of the user to the displayed document;
determining whether any other users need to apply an electronic signature to the displayed document; and
generating a signature detail report if all users have completed applying their electronic signatures to the displayed document.

16. A method as in claim 15, further comprising modifying a signature block of the user with additional information from the user.

17. A method as in claim 15, wherein the prompting for user assent further comprises:
prompting the user for biometric information to indicate assent;
receiving biometric information from the user;
checking the received biometric information against known biometric information about the user retrieved from a biometric data repository; and
proceeding with the application of the electronic signature upon a match between the received biometric information and the retrieved biometric information.
